(19) United States
(12) Patent Application Publication
(10) Pub. No.: US 2013/0097322 A1
(43) Pub. Date: Apr. 18, 2013

(54) SCALABLE DISTRIBUTED MULTICLUSTER DEVICE MANAGEMENT SERVER ARCHITECTURE AND METHOD OF OPERATION THEREOF

(71) Applicants: Jigang Yang, Cedar Park, TX (US); Arabinda Bose, Cedar Park, TX (US); Vinod T. Nair, Austin, TX (US); Eivind Skildheim, Evergreen, CO (US)

(72) Inventors: Jigang Yang, Cedar Park, TX (US); Arabinda Bose, Cedar Park, TX (US); Vinod T. Nair, Austin, TX (US); Eivind Skildheim, Evergreen, CO (US)

(73) Assignee: Alcatel-Lucent USA, Inc., Murray Hill, NJ (US)

(21) Appl. No.: 13/274,955

(22) Filed: Oct. 17, 2011

(51) Int. Cl. G06F 15/173

(52) U.S. Cl. 709/226; 709/223

(57) ABSTRACT

A server architecture for, and method of, managing devices. In one embodiment, the server architecture includes: (1) a plurality of manager clusters and (2) a dispatcher cluster coupled to the plurality of manager clusters and configured to: (2a) receive an initial contact from a device, (2b) assign the device to one manager cluster of the plurality of manager clusters, the one manager cluster becoming a home cluster for the device, (2c) cause data regarding the device to be transferred to the home cluster and (2d) cause the device thereafter to communicate directly with, and be managed by, the home cluster.

### TECHNICAL FIELD

This application is directed, in general, to device management server architectures and, more specifically, to a scalable distributed multicluster device management server architecture and a method of operating the same to carry out device management.

### BACKGROUND

Electronic devices (e.g., computers, smartphones, television “set-top” boxes and home and small business networking equipment, such as routers, gateways and modems) have become ubiquitous parts of the modern world's infrastructure. They exist in a seemingly endless variety of brands, types and capabilities and enable subscribers to take advantage of a vast array of services, depending upon the subscribers' wants, needs and financial resources. As a result, the service providers (e.g., telephone, wireless, cable and satellite television companies and Internet service providers) that offer these services have found it increasingly difficult to manage these devices. They employ large numbers of employees and systems simply to initialize and provision (“bootstrap”) new devices, update software running in devices, enable and disable features and services and communicate with subscribers.

To assist with this evermore frustrating challenge, service providers have turned to sophisticated device management (DM) software systems. In general, DM systems allow a service provider to manage geographically dispersed and disparate devices centrally, comprehensively and far more automatically. Most conventional DM systems manage devices over the Internet.

### SUMMARY

One aspect provides a server architecture for managing devices. In one embodiment, the server architecture includes: (1) a plurality of manager clusters and (2) a dispatcher cluster coupled to the plurality of manager clusters and configured to: (2a) receive an initial contact from a device, (2b) assign the device to one manager cluster of the plurality of manager clusters, the one manager cluster becoming a home cluster for the device, (2c) cause data regarding the device to be transferred to the home cluster and (2d) cause the device thereafter to communicate directly with, and be managed by, the home cluster.

In another embodiment, the server architecture includes: (1) a plurality of manager clusters and (2) a dispatcher cluster coupled to the plurality of manager clusters and configured to: (2a) receive an initial contact from a device, (2b) register the device, (2c) configure at least some service parameters on the device, (2d) assign the device to one manager cluster of the plurality of manager clusters, the one manager cluster becoming a home cluster for the device, (2e) cause data regarding the device to be transferred to the home cluster and (2f) cause the device thereafter to communicate directly with, and be managed by, the home cluster.

Another aspect provides a method of managing devices. In one embodiment, the method includes: (1) receiving an initial contact from a device into a dispatcher cluster, (2) employing the dispatcher cluster to assign the device to one manager cluster of a plurality of manager clusters, the one manager cluster becoming a home cluster for the device, (3) causing data regarding the device to be transferred to the home cluster and (4) causing the device thereafter to communicate directly with, and be managed by, the home cluster.

### BRIEF DESCRIPTION

Reference is now made to the following descriptions taken in conjunction with the accompanying drawings, in which:

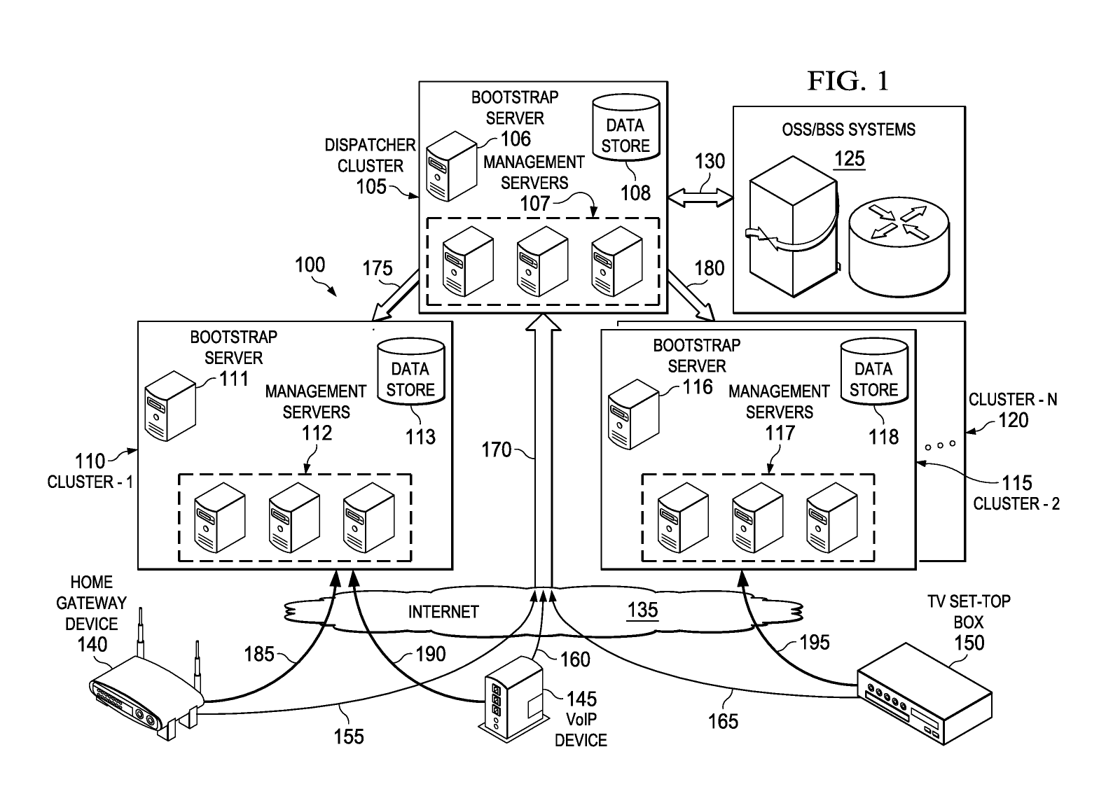

FIG. 1 is a block diagram of one embodiment of a scalable distributed multicluster architecture;

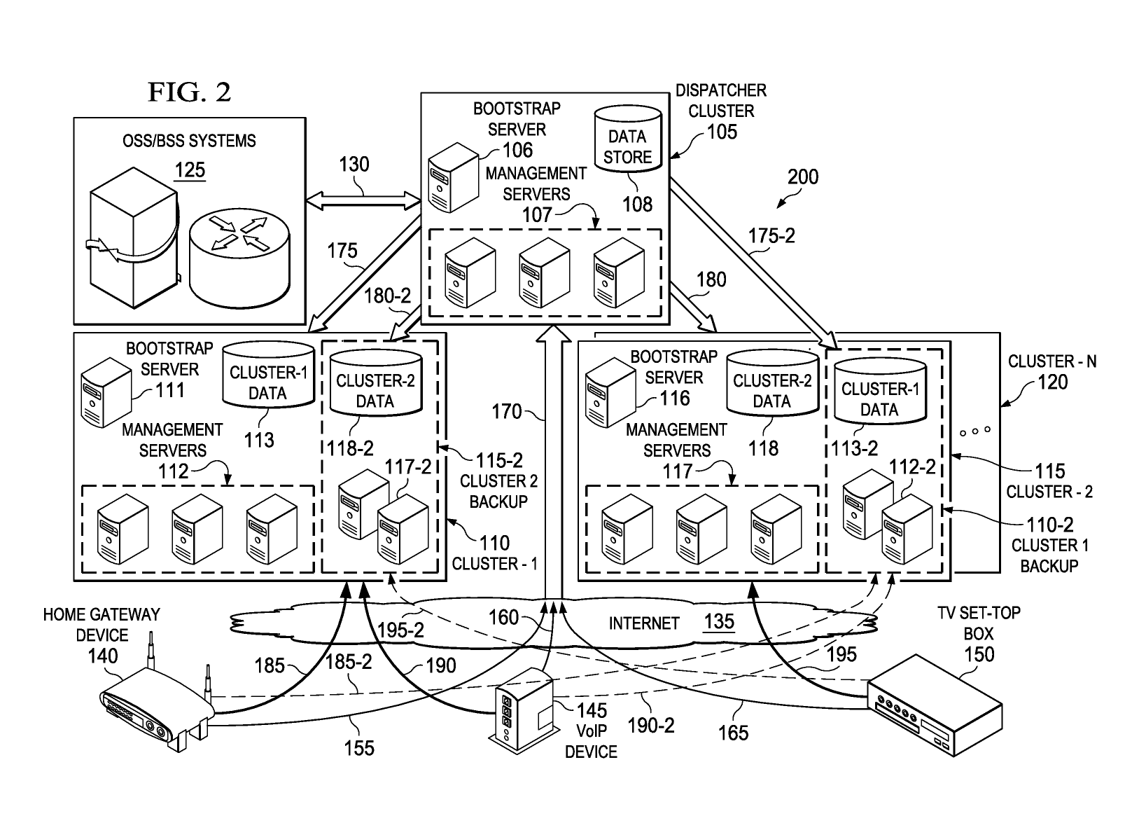

FIG. 2 is a block diagram of one embodiment of a scalable distributed multicluster architecture with disaster recovery;

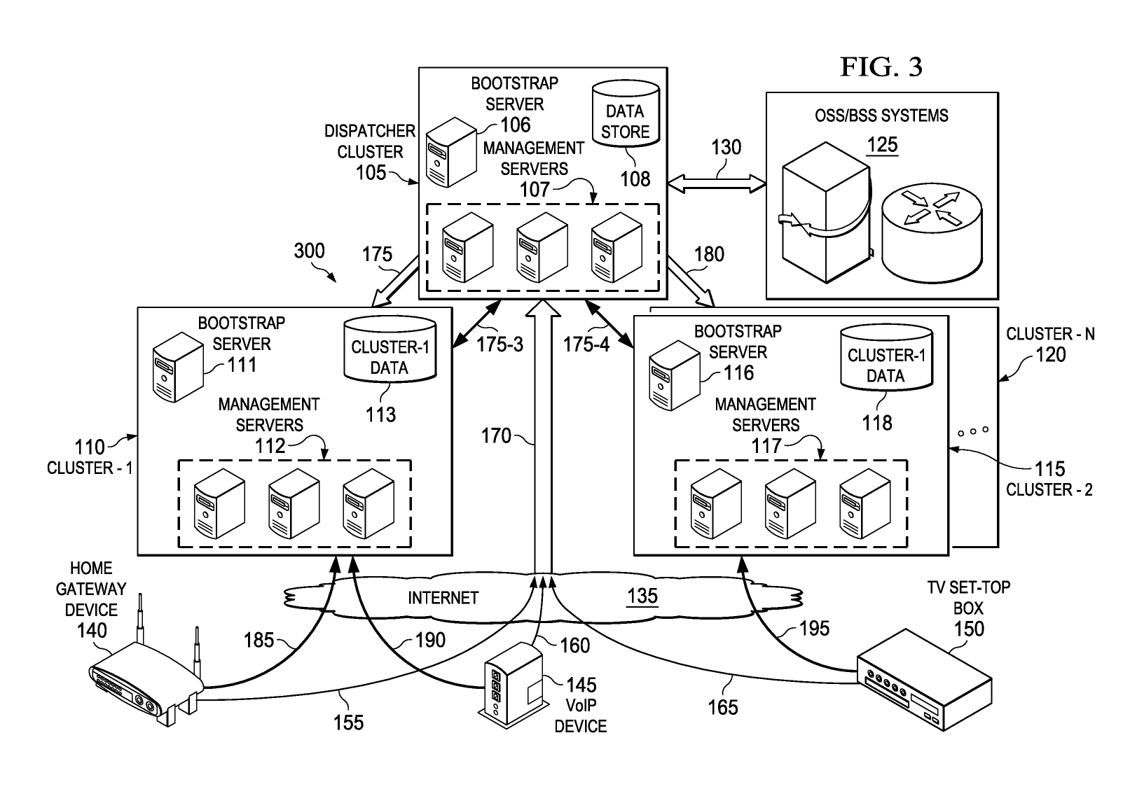

FIG. 3 is a block diagram of one embodiment of a scalable distributed multicluster architecture with dynamic load balancing; and

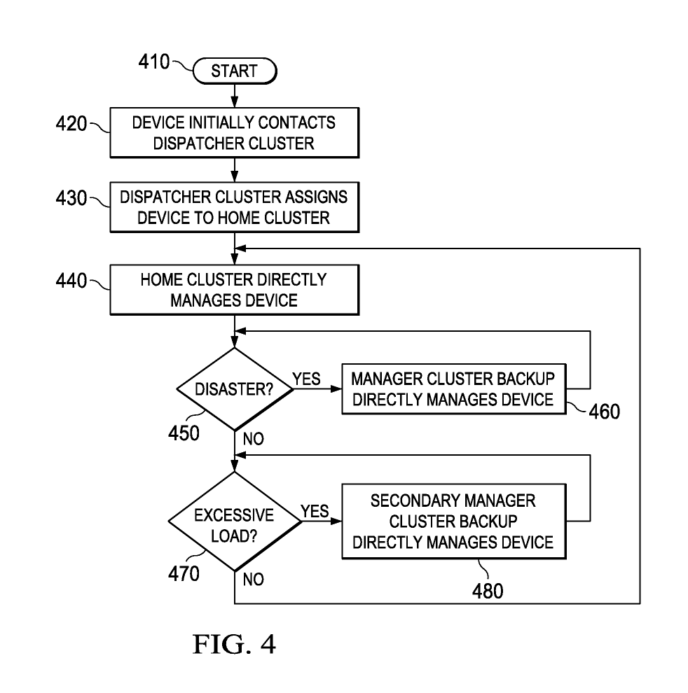

FIG. 4 is a flow diagram of one embodiment of a method of managing devices using a scalable distributed multicluster architecture.

### DETAILED DESCRIPTION

As described above, most conventional DM systems manage devices over the Internet. These DM systems are somewhat scalable in the sense that they can function either with a single network server computer (“server”) or a single cluster made up of a handful servers functioning as peers (i.e., “horizontally”) sharing a common data store. The single server or cluster, whichever the case may be, is responsible for handling all traffic that the DM system receives or generates, including bootstrapping traffic (traffic attendant to initializing devices), management traffic (e.g., traffic attendant to software updating, feature and service enabling and disabling and subscriber communication) and communication with operations support software (OSS) or business support software (BSS).

The number of devices a particular service provider's DM system is tasked with managing generally increases over time, sometimes dramatically. Unfortunately, while conventional DM systems allow a single server to be scaled up to a single cluster and permit a server to be added to a single cluster to increase its size, practical issues soon arise that limit further expansion. This is due to at least four material constraints. First, inter-server communications (those occurring between or among servers in a given cluster) increase approximately exponentially as cluster size grows. Second, cluster administration (including server installations, upgrades and downtime) increase as the cluster size grows. Third, the data store is a single point of failure for the cluster, which increases in risk as the cluster size grows. Fourth, loads experienced within a single-cluster architecture itself are not well partitioned and therefore quickly become unmanageable, and failovers and disaster recovery are problematic. These are not hypothetical constraints. Conventional DM systems servicing, for example, about 10 million devices (which are quite modest deployments these days) are proving fragile and very difficult to operate. By the time such systems are called upon to manage upwards of about 100 million devices,

Introduced herein are various embodiments of a massively scalable (e.g., “massively scalable”) distributed, multicluster MANAGEMENT server architecture. Also introduced are various embodiments of methods of operating the architecture to carry out device management. In one embodiment, the architecture and method allow devices to be managed over the Internet.

In one embodiment, the architecture manages home networking devices. In alternative embodiments, the architecture manages one or more of computers, small business networking devices, communication devices (such as smartphones) and set-top boxes. Other embodiments manage still other conventional or later-developed devices.

Certain of the architecture or method embodiments described herein employ one or more of the following general principals or capabilities:

(i) The management of the same type or similar or different types of devices can be allocated between or among multiple clusters. This allows the architecture to manage many tens or even hundreds of millions of devices.

(ii) A dispatcher cluster may be employed to decide how the management of devices can or should be allocated between or among multiple clusters.

(iii) Each cluster can be scaled by adding more servers to it.

(iv) Each cluster of servers can be administered without materially disrupting the performance and availability of other clusters. In some embodiments, each cluster of servers can be independently administered without disrupting the performance and availability of other clusters whatsoever.

(v) New clusters can be added without materially degrading the performance of the existing clusters. This is a particularly valuable capability when as existing clusters reach their saturation points. In some embodiments, new clusters can be added without degrading the performance of the existing clusters whatsoever.

(vi) Service providers have some flexibility in deciding how the architecture can be adapted to their needs. For example, service providers can decide how the management of devices is to be allocated to multiple clusters (e.g., the management of television set-top boxes can be allocated to one cluster, the management of Voice-over-IP, or VoIP, devices can be allocated to another cluster, and the management of Digital Subscriber Line, or DSL, Internet gateway devices can be allocated to another cluster). As another example, service providers can decide that management of devices should be allocated between or among clusters based on the geographical location of the devices (e.g., devices in an eastern zone that includes New York, Pennsylvania and Virginia can be managed by one clusters, and devices in a western zone that includes California, Oregon and Washington can be managed by another cluster).

(vii) Exceptionally large management loads (those detrimental to the performance of a particular cluster) and therefore dynamically reallocated other clusters. For example, excessive management loads caused by faulty devices, faulty or significant upgrades or faulty servers or interconnections in or to a particular cluster) can create a capacity bottleneck. As long as the exceptionally large load prevails, some of that load can be transferred to other (e.g., secondary) clusters temporarily. In some embodiments, a conventional load balancing strategy is employed for this purpose.

FIG. 1 is a block diagram of one embodiment of a scalable distributed multicluster architecture 100. The architecture includes a dispatcher cluster 105 and manager clusters 1 . . . N, e.g., a manager cluster 1 110, a manager cluster 2 115 and a manager cluster N 120.

The dispatcher cluster 105 includes a bootstrap server 106, a plurality of management servers 107 and a data store 108. In operation, the bootstrap server 106 initializes the plurality of management servers 107 so they can cooperate to perform a particular function. The plurality of management servers 107 employ the data store 108 to perform the particular function. The particular function of the dispatcher cluster 105 includes assigning the management of particular devices to manager cluster 1 110, manager cluster 2 115 and manager cluster N 120.

In the embodiment of FIG. 1, a data path 130 couples the dispatcher cluster 105 to such OSSs and/or BSSs 125 a particular service provider may employ. The OSSs and/or BSSs 125 may provide commands to the dispatcher cluster 105, e.g., to deploy an upgrade to device software or firmware or originate or terminate a particular service. The OSSs and/or BSSs 125 may also gather management data from the dispatcher cluster 105, e.g., to form a basis for billing or marketing efforts by the service provider. In the illustrated embodiment, the OSSs and/or BSSs 125 are commercially available. Those skilled in the pertinent art understand how commercially available OSSs and BSSs may communicate with management systems.

Manager cluster 1 110 includes a bootstrap server 111, a plurality of management servers 112 and a data store 113. In operation, the bootstrap server 106 initializes the plurality of management servers 112 so they can cooperate to perform a particular function. The plurality of management servers 112 employ the data store 113 to perform the particular function. The particular function of manager cluster 1 110 includes the management of particular devices according to assignments by the dispatcher cluster 105. Like manager cluster 1 110, manager cluster 2 115 includes a bootstrap server 116, a plurality of management servers 117 and a data store 118 that cooperate and function like manager cluster 1 110 to manage particular devices in accordance with assignments by the dispatcher cluster 105. Though not shown or referenced, manager cluster N 120 includes a bootstrap server, a plurality of management servers and a data store that cooperate and function like manager clusters 1 and 2 110, 115 to manage particular devices in accordance with assignments by the dispatcher cluster 105.

The dispatcher cluster 105 and the manager clusters (i.e., manager cluster 1 110, manager cluster 2 115 and manager cluster N 120) are coupled to the Internet 135 through which they are coupled to various examples of devices to be managed, including an Internet gateway device 140, a VoIP device 145 and a television set-top box 150. In the illustrated embodiment, manager cluster 1 110, manager cluster 2 115 and manager cluster N 120 are geographically separated from one another, such that an environmental issue (e.g., fire, earthquake or power loss) that might adversely affect one manager cluster likely does not affect the other manager clusters. In one embodiment, the dispatcher cluster 105 is geographically separated from all of the manager clusters 110, 115, 120.

Having described the general structures of various embodiments of the architecture 100 of FIG. 1, various embodiments of its operation will now be described.

In the illustrated embodiment, when a device (e.g., the Internet gateway device, or IGD, 140 (sometimes called a “home gateway device”), the VoIP device 145 or the television set-top box 150) comes online, it initially contacts the dispatcher cluster 105 through the Internet 135. FIG. 1 represents this initial contact by, e.g., the Internet gateway device 140, the VoIP device 145 or the television set-top box 150, with respective arrows 155, 160, 165, 170. In response, the illustrated embodiment of the dispatcher cluster 105 registers the device. In one embodiment, the dispatcher cluster 105 also activates the device. In a more specific embodiment, the dispatcher cluster 105 configures only the most essential service parameters on the device. Once the dispatcher cluster 105 has at least registered the device, one embodiment of the dispatcher cluster 105 then executes one or more configured business rules that, e.g., identify the type of device, the geographic location of the device or the subscriber to whom the device belongs or with whom the device should be associated. This identification culminates in a manager cluster being assigned with managing the device, which then becomes that device's “home cluster.” Once the dispatcher cluster 105 has identified the device's home cluster, one embodiment of the dispatcher cluster 105 then causes data regarding the device (e.g., data essential to the managing of the device) to be transferred (e.g., copied) to the home cluster. FIG. 1 represents this transfer with the appropriate home cluster with respective arrows 175, 180. Finally, the illustrated embodiment of the dispatcher cluster 105 then redirects the device to its home cluster by communicating with the device through the Internet 135, after which the device is managed though direct communication with its home cluster. FIG. 1 represents this direct communication with respective arrows 185, 190, 195.

In the example of FIG. 1, the service provider provides home networking services and has decided that manager cluster 1 110 should manage all of its home gateway devices and VoIP devices and further that the manager cluster 2 115 should manage all of the television set-top boxes. Accordingly, the arrows 185, 190 represent post-activation traffic directed to manager cluster 1 110, and the arrow 195 represents post-activation traffic directed to manager cluster 2 115.

FIG. 2 is a block diagram of one embodiment of a scalable distributed multicluster architecture 200 that provides for disaster recovery. A “disaster” is defined as an event that causes an extended outage of an affected cluster such that another cluster should perform the functions of the affected cluster at least until the affected cluster is returned to service.

The illustrated embodiment provides for disaster recovery by collocating a manager cluster 2 backup 115-2 with manager cluster 1 110 and further collocating a manager cluster 1 backup 110-2 with manager cluster 2 115. Manager cluster 2 backup 115-2 includes a bootstrap server (not shown), a plurality of management servers 117-2 and a data store 118-2. Manager cluster 1 backup 110-2 includes a bootstrap server (not shown), a plurality of management servers 112-2 and a data store 113-2. In one embodiment, the number of management servers 112-2 in manager cluster 1 backup 110-2 is the same as the number of number of management servers 112 in manager cluster 1 110. Likewise, in a related embodiment, the number of management servers 117-2 in manager cluster 2 backup 115-2 is the same as the number of number of management servers 117 in manager cluster 2 115. In an alternative embodiment, the number of management servers in the backups 110-2, 115-2 differs from the number of servers in manager cluster 1 110 and manager cluster 2 115. In a more specific embodiment, the backups 110-2, 115-2 are only expected to operate under emergent circumstances, and therefore the number of management servers in the backups 110-2, 115-2 is less.

In the illustrated embodiment, the data store 113-2 is synchronized with the data store 113, and the data store 118-2 is continually and automatically synchronized with the data store 118. In a related embodiment, in the event of an emergency, a load balancer, perhaps executing in the dispatcher cluster 105, redirects devices that are communicating with manager cluster 2 115 to manager cluster 2 backup 115-2 and devices that are communicating with manager cluster 1 110 to manager cluster 2 backup 110 without manual intervention by either the service provider or the subscriber. FIG. 2 represents this redirection of direct communication by the devices 140, 145, 150 away from manager cluster 1 110 and manager cluster 2 115 instead to manager cluster 1 backup 110-2 and manager cluster 2 backup 115-2 with respective arrows 185-2, 190-2, 195-2.

FIG. 3 is a block diagram of one embodiment of a scalable distributed multicluster architecture 300 that provides for dynamic load balancing. The architecture of FIG. 3 can be used when a load imbalance occurs between or among home clusters. In such case, the service provider has the flexibility to provide business rules that allow one or more other (“secondary”) clusters temporarily to manage devices they would not manage under ordinary circumstances to balance the load. For example, in the example of FIG. 3, if managing the IGDs and VoIP devices (e.g., the IGD 140 and the VoIP device 145) places an undue or undesired strain on manager cluster 1 110, management of those devices may be temporarily or permanently redirected to, e.g., manager cluster 2 115 or another (secondary) cluster (e.g., manager cluster N 120). Arrows 175-3 and 175-4 represent a temporary or permanent redirecting of management responsibility away from manager cluster 1 110 and instead to manager cluster 2 115 or manager cluster N 120.

In the illustrated embodiment, one of the functions of the dispatcher cluster 105 is to detect an unbalanced load between or among the manager clusters 110, 115, 120 and cause management of at least some devices to be temporarily redirected according to business rules. In a related embodiment, the data store 108 of the dispatcher cluster 105 stores home and secondary cluster information for devices, so were a home cluster to reject additional devices due to an excessive load, or is completely unavailable, the dispatcher cluster 105 can route devices to its predesignated secondary cluster(s).

FIG. 4 is a flow diagram of one embodiment of a method of managing devices using a scalable distributed multicluster architecture. The method begins in a start step 410. In a step 420, a device initially contacts a dispatcher cluster. In a step 430, the dispatcher cluster assigns the device to a manager cluster, which then becomes that device's home cluster, and accordingly causes data regarding the device to be transferred to the home cluster. In a step 440, the device thereafter directly communicates with, and is managed by, its home cluster. In a decisional step 450, the home cluster experiences a disaster. Accordingly, the management of the device is redirected to a manager cluster backup in a step 460. In a decisional step 470, the home cluster temporarily experiences an excessive load. Accordingly, management of the device is temporarily or permanently redirected to another (secondary) manager cluster in a step 480.

Those skilled in the art to which this application relates will appreciate that other and further additions, deletions, substitutions and modifications may be made to the described embodiments.

What is claimed is:

1. A server architecture for managing devices, comprising:
a plurality of manager clusters; and
a dispatcher cluster coupled to said plurality of manager clusters and configured to:
receive an initial contact from a device,
assign said device to one manager cluster of said plurality of manager clusters, said one manager cluster becoming a home cluster for said device,
cause data regarding said device to be transferred to said home cluster, and
cause said device thereafter to communicate directly with, and be managed by, said home cluster.

2. The server architecture as recited in claim 1 wherein said dispatcher cluster is further configured to cause said device to communicate directly with, and be managed by, a manager cluster backup instead of said home cluster if said home cluster is affected by a disaster.

3. The server architecture as recited in claim 1 wherein said dispatcher cluster is further configured to cause said device to communicate directly with, and be managed by, a secondary manager cluster instead of said home cluster if said home cluster temporarily experiences an excessive load.

4. The server architecture as recited in claim 1 wherein said dispatcher cluster is further configured to register said device.

5. The server architecture as recited in claim 1 wherein said dispatcher cluster is further configured to activate said device.

6. The server architecture as recited in claim 1 wherein said dispatcher cluster is further configured to assign said device based on a type of said device.

7. The server architecture as recited in claim 1 wherein said dispatcher cluster is further configured to assign said device based on a geographical location of said device.

8. A method of managing devices, comprising:
receiving an initial contact from a device into a dispatcher cluster;
employing said dispatcher cluster to assign said device to one manager cluster of a plurality of manager clusters, said one manager cluster becoming a home cluster for said device;
causing data regarding said device to be transferred to said home cluster; and
causing said device thereafter to communicate directly with, and be managed by, said home cluster.

9. The method as recited in claim 8 further comprising causing said device to communicate directly with, and be managed by, a manager cluster backup instead of said home cluster if said home cluster is affected by a disaster.

10. The method as recited in claim 8 further comprising causing said device to communicate directly with, and be managed by, a secondary manager cluster instead of said home cluster if said home cluster temporarily experiences an excessive load.

11. The method as recited in claim 8 further comprising employing said dispatcher cluster to register said device.

12. The method as recited in claim 8 further comprising employing said dispatcher cluster to activate said device.

13. The method as recited in claim 8 wherein said employing said dispatcher cluster to assign said device comprises employing said dispatcher cluster to assign said device based on a type of said device.

14. The method as recited in claim 8 wherein said employing said dispatcher cluster to assign said device comprises employing said dispatcher cluster to assign said device based on a geographical location of said device.

15. A server architecture for managing devices, comprising:
a plurality of manager clusters; and
a dispatcher cluster coupled to said plurality of manager clusters and configured to:
receive an initial contact from a device,
register said device,
configure at least some service parameters on said device,
assign said device to one manager cluster of said plurality of manager clusters, said one manager cluster becoming a home cluster for said device,
cause data regarding said device to be transferred to said home cluster, and
cause said device thereafter to communicate directly with, and be managed by, said home cluster.

16. The server architecture as recited in claim 15 wherein said dispatcher cluster is further configured to cause said device to communicate directly with, and be managed by, a manager cluster backup instead of said home cluster if said home cluster is affected by a disaster.

17. The server architecture as recited in claim 15 wherein said dispatcher cluster is further configured to cause said device to communicate directly with, and be managed by, a secondary manager cluster instead of said home cluster if said home cluster temporarily experiences an excessive load.

18. The server architecture as recited in claim 15 wherein said dispatcher cluster is further configured to assign said device based on a type of said device.

19. The server architecture as recited in claim 15 wherein said dispatcher cluster is further configured to assign said device based on a geographical location of said device.

20. A server architecture for managing devices, comprising:
a plurality of manager clusters configured to serve as home cluster for ones of said devices; and
a dispatcher cluster coupled to said plurality of manager clusters and configured to assign said device to one manager cluster of said plurality of manager clusters and cause data regarding said device to be transferred to said home cluster, said one manager cluster becoming a home cluster for said device, said server architecture capable scaling by both increasing a number of servers in said plurality of manager clusters and said dispatcher cluster and increasing a number of said plurality of manager clusters.
